(19) United States
(12) Patent Application Publication
(10) Pub. No.: US 2008/0024632 A1
(43) Pub. Date: Jan. 31, 2008

(54) Photographing apparatus and photographing method

(75) Inventor: Ayako Otsuka, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM CORPORATION, Tokyo (JP)

(21) Appl. No.: 11/878,138

(22) Filed: Jul. 20, 2007

(30) Foreign Application Priority Data
Jul. 26, 2006 (JP) 2006-203645

(51) Int. Cl. H04N 3/14

(52) U.S. Cl. 348/294

(57) ABSTRACT

An image is generated which is able to upload to a weblog site as it is from a photographing apparatus. A conversion section converts an original image obtained by a shutter operation of a CCD to have a size for a blog image. A file control section generates a blog image by converting the image after the conversion process by the conversion section to have a predetermined file format. A folder control section stores a blog image in a blog folder, and also stores a normal image having a normal size in a normal folder. A blog posting section sends the blog image stored in the blog folder to a blog server in response to a determination of a communicable state with the blog server.

### BACKGROUND OF THE INVENTION

1. Field of the Invention

The present invention relates to a photographing apparatus which is able to record an image to be released to a weblog site.

2. Description of the Related Art

In recent years, online journal sites, so-called weblog (hereinafter, simply referred to as “blog”), have considerably increased on the Internet. The blog is a site in which contents are automatically arranged to suit the design of the site and to which new contents can be added by inputting the contents to be displayed such as title, sentence, and image through a form special to the site to be sent to a blog server. In this case, since, unlike a conventional way to build homepages, users do not have to use a text editor or a special software, or to change contents of an HTML file to upload, and a manager of a blog site can upload sentences and images as desired to easily update the contents on daily basis like journals. Moreover, blogs (mobile blog, moblog) also have increased as one type of quick blog, the contents of which can be also sent to be displayed from mobile information terminals such as mobile phone and PDA to a blog server.

However, in order to release an image to a blog on line, a user needs to change the standard size of an image which is photographed by a digital camera to an appropriate size to upload.

### SUMMARY OF THE INVENTION

For the convenience of users, a photographed image is preferably uploaded to a blog as it is. However, in the technologies disclosed in Japanese Patent Application Laid-Open Nos. 2003-319326, 2003-309796, and 2003-274341, images that have a proper size to upload to a blog cannot be obtained. The present invention provides a technology for generating an image which can be uploaded to a blog site as it is from a photographing apparatus.

The present invention relates to a photographing apparatus, comprising: a image pickup element for receiving an incident light from an object through a photographing lens and continuously converting the light to a photographing signal to output; an image data converting section for converting the photographing signal which is output from the image pickup element to an image data to output; a record indicating section for inputting a recording indication of the image data; a shutter control section for controlling exposure of the image pickup element in response to the input of the recording indication at the record indicating section; a storing section for storing the image data of the photographing signal output from the image pickup element in response to the exposure control by the shutter control section; and a displaying section for displaying at least the image data stored in the storing section.

The photographing apparatus includes: a mode setting section for setting a blog image recording mode which is a photographing mode for recording a blog image of an image file to be released to a blog site; a folder creating section for separately creating a blog folder which stores a blog image, and a normal folder which stores a normal image of an image file for use in applications such as photographic printing and others except a release to the blog site, in a predetermined recording medium; a blog image generating section for generating a blog image by a predetermined process which is suitable to release an image data stored in the storing section on a blog site, when the mode setting section sets a blog image recording mode; a normal image generating section for generating a normal image based on the image data stored in the storing section; and a recording section for recording the normal image generated by the normal image generating section in the normal folder, and recording the blog image generated by blog image generating section in the blog folder, individually.

According to the present invention, when a blog image recording mode is set, a process suitable to release a stored image data to a blog site is performed in response to an image recording indication, so that a blog image is generated, and at the same time a normal image which can be used in normal purposes such as photographic printing is generated, separately. And the normal image is stored in a normal folder, and the blog image is stored in a blog folder, individually.

As a result, an image suitable to release to a blog site is obtained immediately after a photographing of a normal image, which eliminates a trouble of processing of an image for a blog by a user after the user photographed the image, and improves user convenience in sending an image to a blog site.

Since a blog image is stored in a folder separated from that for a normal image, the generated blog images and normal images are not mixed but are distinguishable from each other.

As an example, the blog image generating section generates a blog image by performing a conversion process for converting an image data stored in the storing section to have an image size suitable to release on a blog site.

As a result, a user does not have to perform a conversion process every time he/she photographs an image, which improves user convenience in sending an image to a blog site.

As an example, the blog image generating section generates a blog image by performing an object extracting process for recognizing an outline of a certain object from an image data stored in the storing section, and extracting an image of the certain object along the outline of the certain object.

As a result, a user does not have to remove an unnecessary background portion of an image by himself/herself before the user releases an image of a certain object, which improves user convenience in sending an image to a blog site.

As an example, the blog image generating section generates a blog image by performing an image process for recognizing an eye area of a person from an image data stored in the storing section, and making it prohibitively difficult to browse the eye area of the person.

As a result, a user does not have to perform a process for concealing eyes of an object in an image to protect privacy of the object, which improves user convenience in sending an image to a blog site.

As an example, the shutter control section repeatedly controls exposure of the image pickup element every predetermined period of time while the record indicating section is receiving a continuous input of recording indications, and the blog image generating section generates a plurality of blog images by performing a continuous shooting information adding process for adding common continuous shooting information to each of the plurality of image data stored in the storing section in response to the continuous recording indications at one time which is input to the record indicating section.

As a result, the receiver is able to identify the plurality of images photographed in one continuous shooting by using the continuous shooting information. The receiver is able to display the plurality of images photographed in one continuous shooting, one by one like a slide show.

As an example, the blog image generating section generates a blog image by performing a combining process for combining the plurality of image data stored in the storing section to one still image data in response to the plurality of recording indications input to the record indicating section.

As a result, the plurality of images obtained at one opportunity can be set to be released as one still image on line.

As an example, the shutter control section controls exposure of the image pickup element while the record indicating section is receiving a continuous input of recording indications, and the blog image generating section performs a video image generating process for creating a video image file which is accommodated within a capacity limit of the blog site based on the image data stored in the storing section in response to the continuous recording indications at one time which is input to the record indicating section.

As a result, a video image file which is accommodated within a capacity limit of the blog site can be obtained without any particular operation by user.

As an example, the blog image generating section generates a blog image by performing a composing process for composing an image data stored in the storing section with a predetermined frame image.

As a result, any desired frame image can be composed to a blog image to release without any particular operation by user.

The photographing apparatus may further include a sending section for sending a blog image recorded in the blog folder to the blog site in response to a connection to the blog site; and an eliminating section for eliminating the blog image sent by the sending section from the blog folder.

In other words, since a blog image is automatically sent, a user does not have to perform a special operation for sending. In addition, when a blog image is sent, the blog image is eliminated from the folder, so that a user does not have to sort out unnecessary blog images by himself/herself.

The displaying section preferably selectively displays image data of one of or both of a blog image recorded in the blog folder and a normal image recorded in the normal folder.

As a result, a duplicate display of a normal image and a blog image which have the same content can be prevented, but the duplicate display is also available when a user wants to see both of them.

The photographing apparatus may further include a process specifying section for specifying a predetermined process which the blog image generating section should perform in response to a setting of a blog image recording mode by the mode setting section, so that the blog image generating section performs the predetermined process specified by the process specifying section.

In other words, a blog image can be generated by any process a user desires.

The predetermined process specified by the process specifying section includes at least one of a conversion process, an object extracting process, an image process for making it prohibitively difficult to browse an eye area of an object person, a continuous shooting information adding process for adding common continuous shooting information to each of the plurality of image data obtained in response to one recording indication, a combining process for combining a plurality of image data to one still image data, a video image generating process for generating video image file which is accommodated within a capacity limit of the blog site, and a composing process for composing a predetermined frame image.

The present invention relates to a photographing method which is used in a photographing apparatus, comprising: an image pickup element for receiving an incident light from an object through a photographing lens and continuously converting the light to a photographing signal to output; an image data converting section for converting the photographing signal which is output from the image pickup element to an image data to output; a record indicating section for inputting a recording indication of the image data; a shutter control section for controlling exposure of the image pickup element in response to the input of the recording indication at the record indicating section; a storing section for storing the image data of the photographing signal output from the image pickup element in response to the exposure control by the shutter control section; and a displaying section for displaying at least the image data stored in the storing section.

The photographing method includes: a step for setting a blog image recording mode which is a photographing mode for recording a blog image of an image file to release on a blog site; a step for creating a blog folder which stores a blog image, and a normal folder which stores a normal image of an image file for use in applications such as photographic printing and others except a release to a blog site, individually in a predetermined recording medium; a step for generating a blog image by performing a predetermined process on an image data stored in the storing section which is suitable to release the image data to the blog site, when the mode setting section sets the blog image recording mode; a step for generating a normal image based on an image data recorded in the storing section; and a step for recording the normal image generated by the normal image generating section into the normal folder, and recording the blog image generated by the blog image generating section into the blog folder, individually.

### BRIEF DESCRIPTION OF THE DRAWINGS

FIG. 1 is a front view showing a digital camera;

FIG. 2 is a rear view showing a digital camera;

FIG. 3 is a block diagram showing a digital camera;

FIG. 4 is a top view showing a mode dial;

FIG. 5 is a schematic view showing a program executed by a main CPU;

FIG. 6 is a flowchart showing a flow of image recording processes according to a first embodiment;

FIG. 7 is a schematic view showing a blog folder and a normal folder which are separately created in a memory card;

FIG. 8 is a view showing a blog image stored in the blog folder to upload to a blog server;

FIG. 9 is a view showing an example of a detailed menu;

FIG. 10 is a flowchart showing a flow of image recording processes according to a second embodiment;

FIGS. 11A and 11B are views showing a blog image which is obtained by extracting a certain object from an original image;

FIG. 12 is a view showing the blog image which is obtained by extracting a certain object and stored in the blog folder;

FIGS. 13A and 13B are views showing an original image from which an eye area is detected, and an image synthesized with a black line on the eyes;

FIG. 14 is a view showing a blog image which is synthesized with the black line and stored in a folder only for blog images;

FIGS. 15A to 15D are views showing a series of images photographed in one continuous shooting;

FIG. 16 is a view showing a series of images which are photographed in one continuous shooting and stored in a blog folder;

FIG. 17 is a view showing a series of images which are photographed in one continuous shooting and serially displayed on a receiver of a blog site;

FIG. 18 is a view showing a blog image obtained by combining a series of images photographed in continuous shootings;

FIG. 19 is a view showing a blog image which is obtained by combining a series of images photographed in continuous shootings and stored in a blog folder; and

FIGS. 20A to 20C are views showing a blog image obtained by composing an original image with a frame image.

### DETAILED DESCRIPTION OF THE PREFERRED EMBODIMENTS

Now, preferred embodiment of the present invention will be explained below with reference the drawings.

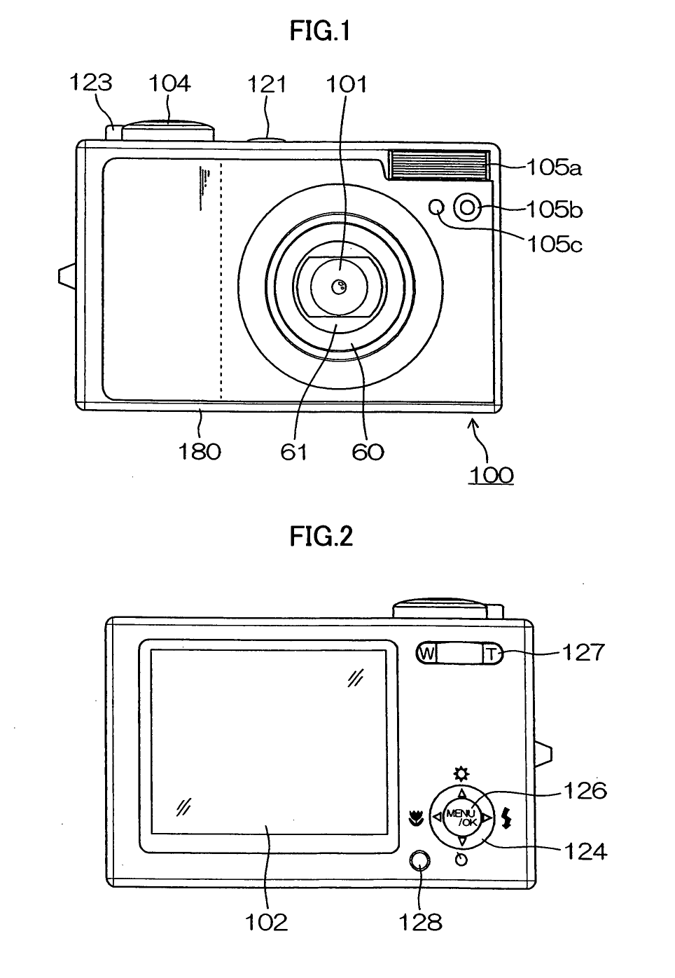

FIG. 1 is a front view showing a digital camera (hereinafter, simply referred to as camera) 100 according to a preferred embodiment of the present invention.

The camera 100 has a lens barrel 60 on the front surface thereof, and the lens barrel 60 is provided with a built-in photographing lens 101 including a zoom lens 101a and a focusing lens 101b, so that a movement of the zoom lens 101a in the direction of the optical axis enables a focal length adjustment, and also a movement of the focusing lens 101b in the direction of the optical axis enables a focus adjustment.

The lens barrel 60 advances and retracts between a wide angle end for the shortest focal length and a telephoto end for the longest focal length, both ends being set in advance, so as to be projected out of and housed in a camera body 180. In FIG. 1, the lens barrel 60 is retracted in the camera body 180.

The camera 100 is also provided with a lens cover 61 for protecting the photographing lens 101 by covering the front surface of the photographing lens 101 to shield it from the outside while the camera 100 is not operated for photographing, and for exposing the photographing lens 101 to the outside for image pickup.

The lens cover 61 is configured with an openable and closable mechanism for covering the front surface of the photographing lens 101 at its open position, and exposing the front surface of the photographing lens 101 to the outside at its closed position. The lens cover 61 is interlocked to a power button 121 to be opened/closed. In FIG. 1, the lens cover 61 is opened.

The camera 100 has a mode dial 123 provided with a central release button 104, and a power button 121 on the top surface thereof, and has an electronic flash unit 105a, an AF auxiliary light lamp 105b, a self-timer lamp 105c and the like on the front surface thereof.

FIG. 2 is a back view showing the camera 100. The camera 100 has a zoom switch 127 on the rear surface thereof. A continuous pressing of a telephoto (T) side of the zoom switch 127 causes the lens barrel 60 to be projected toward the telephoto side, and a continuous pressing of the other side (W) of the zoom switch 127 causes the lens barrel 60 to move toward the wide angle side.

The camera 100 also has an image display LCD 102, a crosskey 124, an information position specifying key 126 and the like on the rear surface thereof. The crosskey 124 is an operation system to set a display brightness control, a self-timer, a macro photography, and a flash photography at the top, bottom, left, and right portions thereof respectively. As explained below, a pressing of the bottom key of the crosskey 124 sets a self photographing mode in which a main CPU 20 causes a CCD image sensor 132 to operate a shutter operation after a clocking of the self-timer circuit 83 is completed.

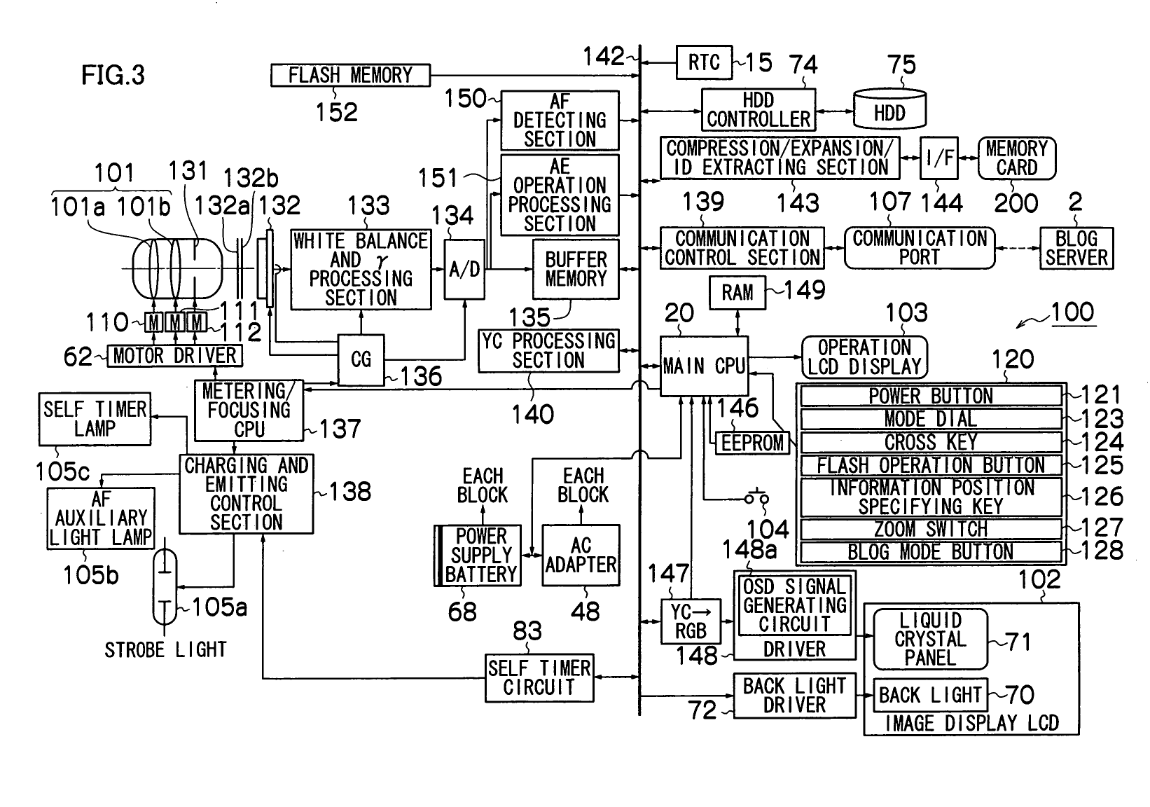

FIG. 3 is a block diagram of the camera 100 according to the first embodiment. The camera 100 is provided with an operating section 120 for various operations associated with a use of the camera 100 by a user. The operating section 120 includes a power button 121 for supplying power to operate the camera 100, a mode dial 123 for selecting an auto photography, a manual photography or the like, a crosskey 124 for setting or selecting different menu or zooming, a flash operation button 125, and an information position specifying key 126 for implementing or canceling the menu selected by the crosskey 124.

The camera 100 is also provided with an image display LCD 102 for displaying a photographed image, reproduced image or the like, and an operation LCD display 103 for assisting the operations.

The camera 100 includes a release button 104. A pressing of the release button 104 informs a main CPU 20 of a start of photographing. The camera 100 is switchable between a photographing mode and a reproducing mode by using a predetermined menu screen. The camera 100 is also provided with an AF auxiliary light lamp 105b having light emitting diodes (LED) for emitting a spot light to an object in a contrast AF mode, and a flash operation device having an electronic flash unit 105a for flashing light.

The camera 100 is also provided with a photographing lens 101, an aperture 131, and a CCD image sensor 132 (hereinafter, simply referred to as CCD 132) which is an image pickup element for converting the object image which is formed through the photographing lens 101 and the aperture 131 into an analog image signal. The CCD 132 generates an image signal by accumulating the charges generated by the object light incident on the CCD 132 for a variable charge storage time (exposure time). The CCD 132 sequentially outputs an image signal for each frame at a timing synchronized with the vertical synchronizing signal VD which is output from a CG section 136.

When the used image pickup element is the CCD 132, an optical lowpass filter 132a is provided thereto which removes unnecessary high frequency components in an incident light in order to prevent generation of a color error signal, moire fringe or the like. Also, an infrared cut filter 132b is provided for absorbing or reflecting the infrared rays of the incident light to correct the sensitivity characteristics inherent to the CCD sensor 132 which has a high sensitivity to a longer wavelength range. The optical lowpass filter 132a and infrared cut filter 132b may be arranged in any manner without being limited to any particular aspect.

The camera 100 is also provided with a white balance and y processing section 133 which includes an amplifier where amplification factor is variable, for adjusting the white balance of the object image represented by the analog image signal from the CCD sensor 132, controlling the slope (y) of the straight line in the gradient characteristics of the object image, and amplifying the analog image signal.

The camera 100 is also provided with an A/D converting section 134 for A/D converting the analog signal from the white balance and y processing section 133 into digital R, G, and B image data, and a buffer memory 135 for storing the R, G, and B image data from the A/D converting section 134.

The R, G, and B image data obtained by the A/D converting section 134 is also input to an AF detecting section 150. The AF detecting section 150 integrates and averages the R, G, and B image data on the basis of a predetermined divided area in one screen and a color component of the screen, and further calculates the integral average values Ir, Ig, and Ib of the R, G, and B image data for the entire areas for each frame. The integral average values Ir, Ig, and Ib are the received amounts of visible light in R, G, and B, respectively.

However, the received amounts Ir, Ig, and Ib of visible light in R, G, and B can also be detected by an optical sensor (not shown) other than CCD 132 which has sensitivities for each visible light in R, G, B.

The camera 100 is also provided with the CG (clock generator) section 136, a CPU for metering/focusing CPU 137 a charging and flashing control section 138, a communication control section 139, a YC processing section 140, and a power supply battery 68.

The CG section 136 outputs vertical synchronizing signals VD for driving the CCD 132, driving signals including a high speed output pulse P, control signals for controlling the white balance and y processing section 133 and the A/D converting section 134, and control signals for controlling the communication control section 139. The CG section 136 receives control signals which are input by a metering/focusing CPU 137.

The metering/focusing CPU 137 controls a zoom motor 110, a focus motor 111, and an aperture motor for aperture adjustment 112 to drive the zoom lens 101a, focusing lens 101b, aperture 131 respectively, so that the distance to the object is calculated (focusing), and the CG section 136 and the charging and flashing control section 138 are controlled. The driving of the zoom motor 110, the focus motor 111, and the aperture motor 112 is controlled by a motor driver 62, control command for motor driver 62 is sent from the metering/focusing CPU 137 or the main CPU 20.

The driving source of the zoom lens 101a, the focusing lens 101b, the aperture 131, and the AF auxiliary light lamp 105 is not necessarily limited to various motors such as the zoom motor 110, the focus motor 111, and the aperture motor 112, and may be an actuator for example.

The metering/focusing CPU 137 measures the brightness of the object (calculation of EV value) based on the image data (through image) periodically obtained (every 1/30 seconds to 1/60 seconds) by the CCD 132 when the release button 104 is half pressed (S1 is on).

That is, an AE operation processing section 151 integrates the R, G, and B image signals output from the A/D converting section 134, and provides the resultant integrated value to the metering/focusing CPU 137. The metering/focusing CPU 137 detects an average brightness of the object (object luminance) based on the integrated value input from the AE operation processing section 151, and calculates an exposure value (EV value) which is appropriate to photographing.

Then, the metering/focusing CPU 137 determines an exposure value including an aperture value (F value) of the aperture 131 and an electronic shutter (shutter speed) of the CCD 132 based on the obtained EV value and according to a predetermined program diagram (AE operation).

A full pressing of the release button 104 (S2 is on) causes the metering/focusing CPU 137 to drive the aperture 131 based on the determined aperture value, control the diameter of the aperture 131, and control the charge storage time at the CCD 132 via the CG 136 based on the determined shutter speed.

The AE operation includes aperture priority AE, shutter speed priority AE, program AE, and the like, and either operation is controlled to pickup image with a proper exposure, by measuring an object luminance and photographing with an exposure value, that is, a combination of an aperture value and a shutter speed, which is determined based on the measured value of the object luminance. This achieves an elimination of the troublesome process to determine an exposure.

The AF detecting section 150 extracts an image data, which corresponds to the detecting range selected by the metering/focusing CPU 137, from the A/D converting section 134. A focal position is detected using the characteristics of a high frequency component in the image data which has the maximum amplitude at the focused point. The AF detecting section 150 integrates the high frequency components in the extracted image data for one field so as to calculate an amplitude value. The AF detecting section 150 serially performs the calculation of the amplitude value while the metering/focusing CPU 137 controls the focus motor 111 to drive the zoom lens 101a to move within the movable range, that is between an infinite side (INF point) and a near side end (NEAR point), and sends the detected value to the metering/focusing CPU 137 when the maximum amplitude is detected.

The metering/focusing CPU 137, after obtaining the detected value, issues a command to the focus motor 111 to cause the focusing lens 101b to move to the focused position corresponding to the detected value. The focus motor 111 causes the focusing lens 101b to move to the focused position, in response to the command issued by the metering/focusing CPU 137 (AF operation).

The metering/focusing CPU 137 is connected to the release button 104 by way of the communication with the main CPU 20, and when a user presses the release button 104 halfway, the detection of a focused position is performed. The metering/focusing CPU 137 is connected to the zoom motor 110, so that when the main CPU 20 acquires a command for a zooming in the TELE direction or WIDE direction by the zoom switch 127 from a user, a driving of the zoom motor 110 allows the zoom lens 101a to move between the WIDE end and the TELE end.

The charging and flashing control section 138 charges a flashing capacitor (not shown) for flashing the electronic flash unit 105a when powered by a power battery 68, and controls the flashing of the electronic flash unit 105a.

The charging and flashing control section 138 controls the power supply to the self-timer lamp (tally lamp) 105c and the AF auxiliary light lamp 105b so that a desired light amount can be obtained at a desired timing, in response to the start of the charge of the power battery 68 and the receipt of various signals including the half pressed/fully pressed operation signal of the release button 104 and the signals showing the light amount and flashing timing from the main CPU 20 and the metering/focusing CPU 137.

The self-timer lamp 105c may use LEDs and the LEDs may be common to those used in the AF auxiliary light lamp 105b.

The main CPU 20 is connected to the self-timer circuit 83. When a self photographing mode is set, the main CPU 20 performs a clocking based on a fully pressed signal of the release button 104. During the clocking, the main CPU 20 causes the self-timer lamp 105c to blink with the blinking speed being increased as the remained time decreases, through the metering/focusing CPU 137. The self-timer circuit 83 inputs a clocking completion signal to the main CPU 20 upon the completion of the clocking. Then the main CPU 20 causes the CCD 132 to perform a shutter operation based on the clocking completion signal.

A communication control section 139 includes a communication port 107, and the communication control section 139 communicates data with its external apparatuses by sending a signal of an object image which is photographed by a camera 100 to the external apparatuses such as a blog server 2 via the communication port 107 by using a wired or wireless network, and receiving data such as a web page content from the external apparatuses via the communication port 107 by using a wired or wireless network.

The camera 100 has a function which is mimic to the switching function of a standard camera for photographing onto a roll of a film to switch between ISO film speeds 80, 100, 200, 400, 1600, and when a film speed of ISO 400 or more is selected, the amplification factor of an amplifier included in the white balance and y processing section 133 switches to a high sensitivity mode in which the amplification factor is set to be higher than a predetermined amplification factor. The communication control section 139 disconnects the communication with an external apparatus during the photographing in a high sensitivity mode.

The camera 100 is further provided with a compressing/expanding/ID extracting section 143 and an I/F section 144. The compressing/expanding/ID extracting section 143 reads out an image data stored in the buffer memory 135 through a bus line 142 and compresses the image data, which is stored in the memory card 200 via the I/F section 144. The compressing/expanding/ID extracting section 143 also extracts an identification number (ID) unique to the memory card 200 when it reads out an image data stored in the memory card 200, so that the compressing/expanding/ID extracting section 143 reads out the image data stored in the memory card 200, and expands and stores it in the buffer memory 135.

A Y/C signal stored in the buffer memory 135 is compressed by the compressing/expanding/ID extracting section 143 according to a predetermined format, and then is recorded to a removable medium such as the memory card 200 or built-in high-capacity storage media such as a hard disk (HDD) 75 via the I/F section 144 in a predetermined format (for example, Exif (Exchangeable Image File Format) file). A recording of a data to the hard disk (HDD) 75 or a reading of a data from the hard disk (HDD) 75 is controlled by the hard disk controller 74 in response to a command issued by the main CPU 20.

The camera 100 is also provided with the main CPU 20, an EEPROM 146, a YC/RGB conversion section 147, and a display driver 148. The main CPU 20 provides overall controls of the camera 100. The EEPROM 146 stores individual data and programs unique to the camera 100. The YC/RGB conversion section 147 converts a color video signal YC generated at the YC processing section 140 into a three-color RGB signal, and outputs the converted signal to the image display LCD 102 via the display driver 148.

The camera 100 has an AC adapter 48 and a power battery 68 removably attached thereto for an electric power supply from an AC power source. The power battery 68 may be a rechargeable secondary battery such as a Nickel-Cadmium battery, a nickel hydrogen battery, or a lithium ion battery. Alternatively, the power battery 68 may be a single use primary battery such as a lithium battery or an alkaline battery. The power battery 68 is mounted in a battery housing chamber (not shown) to be electrically connected to each circuit of the camera 100.

When the AC adapter 48 is mounted to the camera 100 for an electric power supply from the AC power source to the camera 100 via the AC adapter 48, even if the power battery 68 is mounted to the battery housing chamber, the electric power output from the AC adapter 48 has the priority to be supplied to each section of the camera 100 as a driving electric power. When the AC adapter 48 is not mounted to the camera 100 and the power battery 68 is mounted to the battery housing chamber, the electric power output from the power battery 68 is supplied to each section of the camera 100 as a driving electric power.

Although not shown, the camera 100 is provided with a backup battery other than the power battery 68 which is mounted to the battery housing chamber. The built-in backup battery may be a dedicated secondary battery which is charged by the power battery 68, for example. The backup battery supplies power to the basic functions of the camera 100 when the power battery 68 is not mounted to the battery housing chamber for its replacement or removal.

That is, a stoppage of power supply from the power battery 68 or the AC adapter 48 causes a switching circuit (not shown) to connect the backup battery to a RTC 15 for a power supply to the circuits. This enables a continuous power supply to the basic functions including the RTC 15 until the end of the useful life of the backup battery 29.

The RTC (Real Time Clock) 15 is a dedicated chip for clocking, and remains in continuous operation with the electric power supply from the backup battery even while a power supply from the power battery 68 or the AC adapter 48 is stopped.

The image display LCD 102 is provided with a back light 70 which illuminates a transmissive or semi-transmissive liquid crystal panel 71 from its rear surface side, and in a power saving mode, the main CPU 20 controls the brightness (luminance) of the back light 70 via a backlight driver 72, so that the power consumption by the back light 70 can be reduced. The power saving mode can be turned on/off when the information position specifying key 126 of the operation section 120 is pressed to cause the image display LCD 102 to display a menu screen and a predetermined operation is executed on the menu screen.

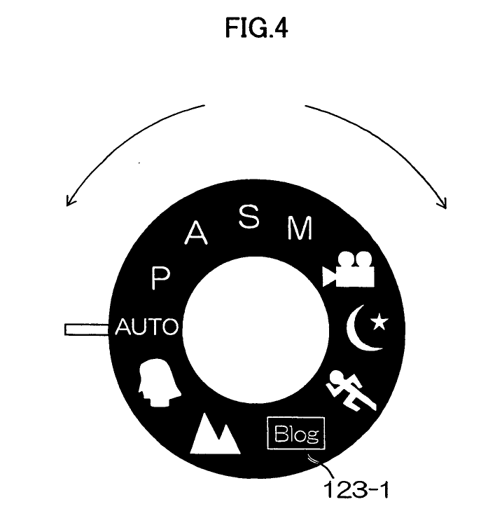

FIG. 4 is a top view of the mode dial 123. The mode dial 123 is configured with a rotary dial switch. The mode dial 123 is printed with icons which provide intuitive illustrations for each of the operation modes. The mode dial 123 is rotatable in the direction shown by an arrow of FIG. 4 (clockwise or counter-clockwise), so that a person who picks up an image can select an operation mode by rotating the mode dial 123 to a position where a suitable icon for the desired operation is aligned with an alignment mark 97.

In FIG. 4, an icon 123-1 corresponds to a “blog mode”. The other photographing modes include for example a still image photographing mode for photographing still images, and a video image photographing mode for photographing video images, and the image photographing mode for still images further includes an auto mode for automatically setting photographing conditions such as shutter speed and aperture value, a manual mode for manually setting the photographing conditions, and various photographing modes for automatically setting proper photographing conditions such as shutter speed, aperture value, exposure value, white balance, and the like depending on various photographing scenes like a photographing of people, a photographing of landscape, a photographing of sports, a photographing of night view (people mode, portrait image pickup mode, landscape mode, sports mode, and night view mode).

An alignment of the icon 123-1 of the “blog mode” with the alignment mark 97 achieves the setting of the blog mode. Upon the setting of the blog mode, in recording an image, processes for the mode are performed.

However, the operation modes do not necessarily have to be set by using the mode dial 123. For example, the operation modes including the blog mode and others may be configured to be selected from the image pickup mode menu displayed on the image display LCD 102 by an operation of the crosskey 124 and the information position specifying key 126.

Alternatively, as shown in FIG. 2, a “blog mode” button 128 may be provided to an outer surface of the camera body as a part of the operating section 120, so that the blog modes can be set in response to the pressing of the “blog mode” button 128.

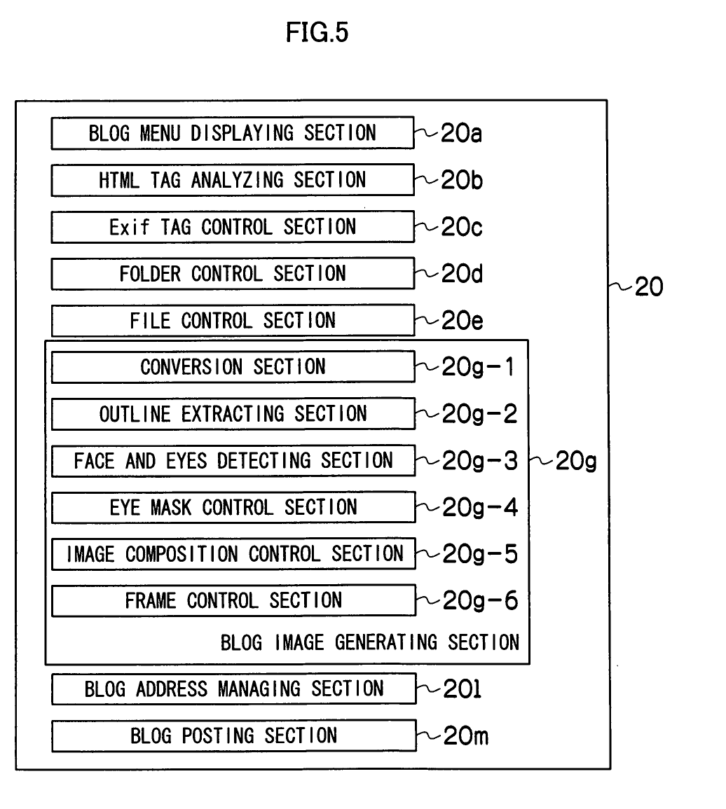

FIG. 5 is a schematic view showing a program executed by a main CPU 20 as a block diagram. The main CPU 20 executes a blog menu displaying section 20a, an HTML tag analyzing section 20b, an Exif tag control section 20c, a folder control section 20d, a file control section 20e, a blog image generating section 20g, a blog address managing section 201, and a blog posting section 20m which are the program module stored in computer readable storage media such as an EEPROM 146 and a hard disk 75.

The blog menu displaying section 20a controls an OSD signal generating circuit 148a to generate and output a video signal of a blog menu and a detailed menu which will be explained below. The video signal of the blog menu output from the OSD signal generating circuit 148a is mixed with an image signal from a YC/RGB conversion section 147 to be supplied to a liquid crystal panel 71.

The HTML tag analyzing section 20b analyzes an HTML tag of a HTML file into which web pages are described such as a blog site received from the blog server 2, and displays a web page based on the result of the analysis on the liquid crystal panel 71.

The blog address managing section 201 manages saving, modification, deletion, and addition of an URL of a blog site on a certain blog server 2 to which the blog is uploaded. The URL of a blog site is saved in the EEPROM 146, the HDD 75, or a flash memory (not shown) for example.

The blog posting section 20m sends a blog image in a blog folder which will be explained below or a sentence specified according to an operation at the operating section 120 to a blog server 2 which is specified at the blog site.

The folder control section 20d creates a blog folder in which an image sent by the blog posting section 20m as a blog image is stored, and a normal folder in which an image for use in normal applications such as photographic printing and screen display (normal image) is stored, separately in a memory card 200. The storage of images in separate folders allows the images to be sorted between normal image and blog image. The normal folder and the blog folder do not have to be created in one recording medium. For example, the normal folder and the blog folder may be created in separate recording media by creating a normal folder in the memory card 200 and creating a blog folder in the HDD 75 or the flash memory (not shown).

The file control section 20e controls reading and writing of an image file, including an extraction of an image file in the memory card 200 and a compression and recording of an image data in the buffer memory 135.

The blog image generating section 20g includes a plurality of program modules such as a conversion section 20g-1, an outline extracting section 20g-2, a face and eyes detecting section 20g-3, an eye mask control section 20g-4, an image composition control section 20g-5, and a frame control section 20g-6. The blog image generating section 20g generates a blog image by executing at least one of the plurality of program modules.

The conversion section 20g-1 has a function for converting an image stored in the buffer memory 135 to have a size suitable to post to a blog (conversion function). The degree of conversion can be optionally specified through an operating section 120.

The outline extracting section 20g-2 recognizes an outline of a certain object such as a ball, an architectural structure, a vehicle, and the like of an image stored in the buffer memory 135. The outlines of certain objects are registered as outline patterns in the HDD 75 for example in advance. Then the outline extracting section 20g-2 recognizes an outline by assuming that a center of the object is disposed at the AF point and recognizing or estimating a closed curve around the center (connected outline). Alternatively, the outline extracting section 20g-2 may recognize a certain outline by detecting contrast differences or edge portions of an image and matching them with outline patterns. After recognition of a certain outline, the outline extracting section 20g-2 extracts an image area surrounded by the outline.

The face and eyes detecting section 20g-3 detects a face area which includes a face of a person from an image stored in the buffer memory 135. The detection of a face area may be performed by using the technology disclosed in Japanese Patent Application Laid-Open No. H9-101579 filed by the inventor of the present invention.

In the technology, it is determined if the color tone of each pixel in a photographed image is within the skin color range or not so that a skin color region and a non skin color region of the image are defined, and an edge in the image is detected so that every point of the image is categorized into an edge part or a non-edge part. Then, a region which locates in the skin color region, is consisted of the pixels categorized as the non-edge part, and is surrounded by the pixels determined to be the edge part is extracted as a face candidate region, and then it is determined if the extracted face candidate region corresponds to the face of the person or not, thereby a region is detected as a face area based on the determined result. Alternatively, a face area may be detected by using the method described in Japanese Patent Application Laid-Open No. 2003-209683 or Japanese Patent Application Laid-Open No. 2002-199221.

The face and eyes detecting section 20g-3 further detects an eye area which includes eyes from the detected face area of the image. The eye area can be detected according to a positional relationship relative to a generally central position of the face which is obtained as a result of the face detection.

The eye mask control section 20g-4 performs an image process for making it prohibitively difficult to browse the eye area of an object detected by the face and eyes detecting section 20g (for example, an image process to hide the eye area of an object) to make browsing of the eyes of the object prohibitively difficult to protect the privacy and portrait right of the object. The image process may include an image synthesizing process which uses a black line and the like, a mosaic process, a resolution lowering process, a blurring process, and an embossing process.

The image composition control section 20g-5 generates one still image by combining a plurality of images stored in the buffer memory 135.

The frame control section 20g-6 generates one new image by composing a pre-specified fame image with an image stored in the buffer memory 135.

### First Embodiment

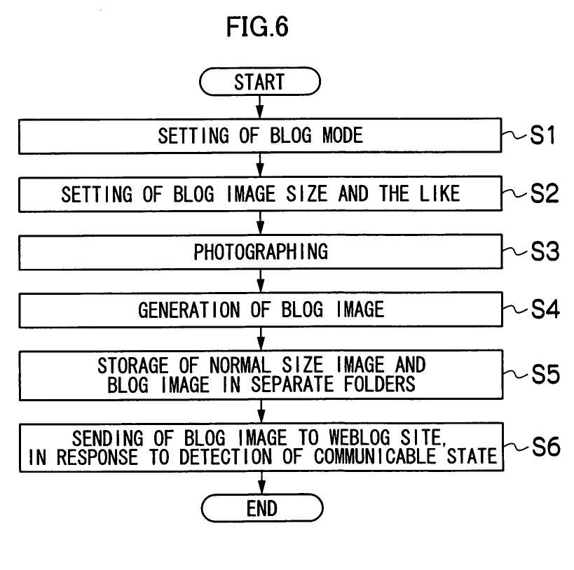

Now, with reference to the flowchart of FIG. 6, a flow of image recording processes which are executed by the CPU 20 will be explained below.

At S1, a “blog mode” is set by the “blog mode” button 128 or the mode dial 123.

At S2, through an initial menu (not shown), a setting of an image size to upload as an image for a certain blog site (a size for blog, for example, VGA), a setting of an address of the blog server 2, and a setting of a size of a normal image (normal size, for example 5M) are input to the conversion section 20g-1. The folder control section 20d creates a folder for storing only blog images (blog folder) and a folder for storing only normal images (normal folder) in the memory card 20. However, when both of the folders already exist, the folder control section 20d does not create them.

At S3, the CCD 132 is caused to perform a shutter operation in response to a pressing of the release switch 104 to obtain an image data.

At S4, as a result of the shutter operation, the conversion section 20g-1 performs a conversion process on the image data stored in the buffer memory 135 (original image) in accordance with the set image size for blog (for example, VGA (640×480)). Then the file control section 20e generates a blog image by converting the converted image by the conversion section 20g-1 to an image of a predetermined file format (Exif format or JPEG format). A normal image is generated which is used in applications other than a release to a web blog such as photographic printing, by the conversion section 20g-1 converting an original image which has not been processed or has been subjected appropriate image processing to have normal size and by the file control section 20e converting the original image having a normal size to an image of a predetermined file format.

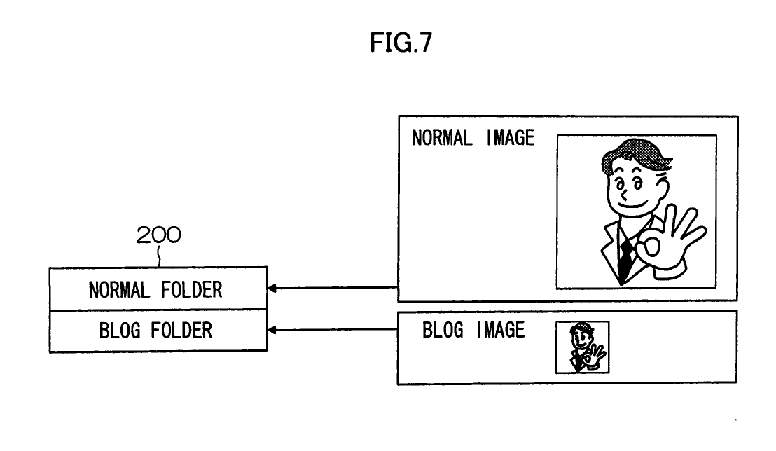

At S5, the folder control section 20d stores the blog image to the blog folder, and also stores the normal image to the normal folder (see FIG. 7).

At S6, the blog posting section 20m determines if the blog server 2 is in a communicable state or not. For example, the determination is made based on a connection between the communication control section 139 and a wireless communication spot of the blog server 2. When it is determined that the blog server 2 is in a communicable state, the blog posting section 20m sends the blog image stored in the blog folder to the blog server 2 (see FIG. 8). After sending the blog image, the blog posting section 20m eliminates the blog image from the blog folder. However, the normal image is still stored in the normal folder.

As described above, the camera 100 according to the present embodiment generates an image having a size which is suitable to post to a blog at the time of photographing, and saves a blog image and a normal image in separate folders. Therefore, a user does not have to perform a conversion process by himself/herself for every posting of an image to a blog.

The camera 100 automatically sends a blog image to the blog server 2 upon a detection of a communicable state of the blog server 2, thereby a user does not have to access the blog server 2 to send a blog image by himself/herself for every posting of a blog image.

The camera 100 also automatically eliminates the sent blog image, and so a user does not have to sort out unnecessary blog images by himself/herself after posting.

That is, the generation, sending, and sorting of images which having a size suitable to post on a blog are all automatically performed, and a user does not have to think about these operations on images to be posted on a blog.

Furthermore, since a normal image is separately stored in a normal folder, the normal image can be used in other applications such as photographic printing and a display on LCD 102.

### Second Embodiment

As shown at S5 of the image recording process of the first embodiment, a normal image is stored in a normal folder and a blog image is stored in a blog folder to be distinguished from each other. By taking advantage of the system, the images are set to be displayed on the LCD 102, based on a display manner selected from a display of only normal image, a display of only blog image, and a display of both of normal image and blog image.

For example, one of a “Display Image Only In Normal Folder” item, a “Display Image Only In Blog Folder” item, and a “Display Both Images In Normal Folder And In Blog Folder” item is set to be able to be selected from a predetermined menu screen.

When the “Display Image Only In Normal Folder” item is selected, the file control section 20e controls the compressing/expanding/ID extracting section 143 to read out and expand a normal image stored in the normal folder which is created in the memory card 200 so as to store the image in the buffer memory 135. A Y/C signal stored in the buffer memory 135 is converted to an RGB signal via the YC/RGB conversion section 147 to be output to the image display LCD 102 through a driver 148 for display.

The file control section 20e also recognizes a blog folder in the memory card 200, but even if an image stored in the blog folder is specified to display, the file control section 20e ignores the operation and does not read out or expand the blog image by using the compressing/expanding/ID extracting section 143.

As a result, the normal image is displayed on the LCD 102 and no blog image is displayed on the LCD 102, which prevents a duplicate display of the normal image and a blog image which have different sizes and substantially same contents.

When the “Display Image Only In Blog Folder” item is selected, an image stored in the blog folder is read out, and a specification of reading out an image stored in the normal folder is ignored, so that only the blog image is displayed on the LCD 102.

When the “Display Both Images In Normal Folder And In Blog Folder” item is selected, both of an image stored in the normal folder and an image stored in the blog folder can be read out, so that both of the normal image and the blog image can be displayed on the LCD 102.

A case can be assumed where a user particularly desires to see both of a normal image and a blog image having a common object for comparison. Thus, among the images stored in the normal folder and the images stored in the blog folder, the images having a common object are imparted with common identification information. For example, common tag information or common header information may be imparted to both of the normal image and the blog image generated based on a common original image.

Then, a “Display For Comparison” item is provided as a sub-item of the “Display Both Images In Normal Folder And In Blog Folder” item, and when the “Display For Comparison” item is selected, the normal image and the blog image having the common identification information are read out from the normal folder and the blog folder respectively, and the images are displayed in a parallel arrangement or in a layout like master and slave, or displayed to be alternately switched, so that both of the images can be seen for comparison.

### Third Embodiment

Other than a reduction of an original image size, various image processes which are optionally specified by a user may be performed on an original image to generate a blog image.

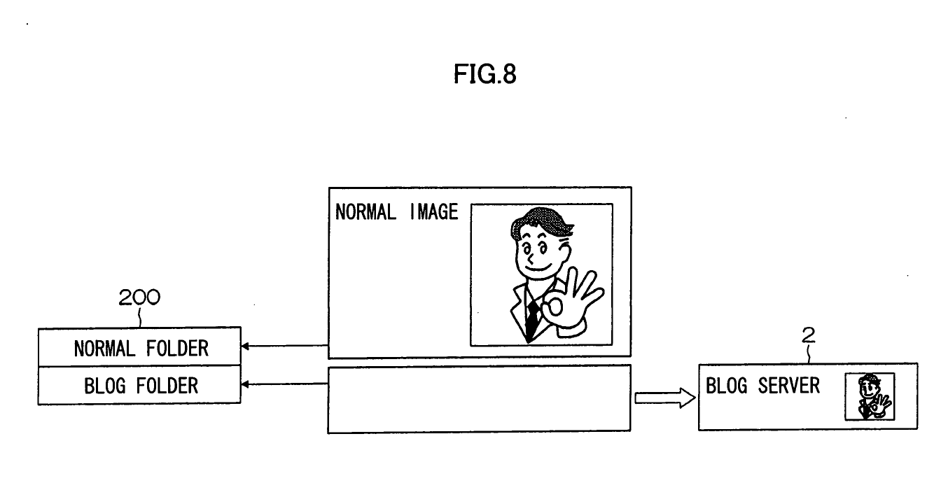

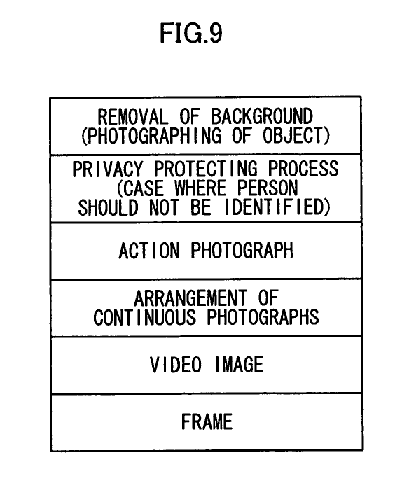

For example, one or a plurality of image processes to be performed for generation of a blog image from an original image is set to be able to be selected using a detailed menu as shown in FIG. 9, the images processes including “Removal of Background”, “Privacy Protecting Process”, “Action Photograph”, “Arrangement of Sequential Photographs”, “Video image”, and “Frame”, for example. A specified image process by using a detailed menu should be displayed in advance before photographing. As one of the menu items, “Reduction” may be further added for specifying a conversion process.

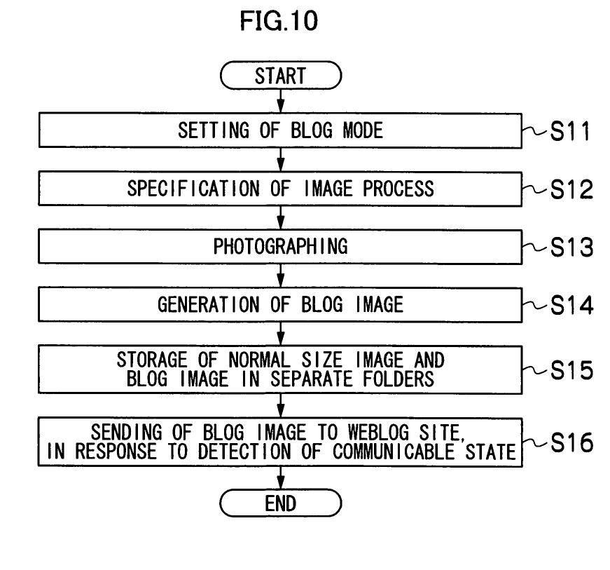

FIG. 10 is a schematic view showing a flow of image recording processes which include a process for specifying an image process by using a detailed menu.

At S11, a process similar to the above described S1 is performed.

At S12, a detailed menu is displayed on the LCD 102 in response to the setting of the blog mode, and one or a plurality of image processes to be performed on an original image is specified.

At S13, a process similar to the above described S3 is performed.

At S14, the blog image generating section 20g starts a module which corresponds to the image process specified using the detailed menu, and performs the specified image process on an original image to generate a blog image. Similar by to S4, a normal image is also generated.

At S15, the file control section 20e, similar by to S5, stores a normal image in a normal folder, and stores a blog image in a blog folder. However, since the resulting blog images are preferably stored in each folder after a check if the images are what a user wants or not, the images that are obtained by performing the specified image process on the original image (processed image) are displayed on the LCD 102.

At this point, when “OK” is input through an information position specifying key 126, the file control section 20e generates a blog image by converting the processed image to an image of a predetermined file format, and stores the image in the blog folder. If “NG” is input through the information position specifying key 126, the obtained processed image is discarded from the buffer memory 135.

If it is desired to emphasize that a processed image is independent of the normal image, regardless of which one of “OK” or “NG” is input through the information position specifying key 126, the normal image may be stored in the normal folder. Alternatively, if it is desired to link the storage of the normal image with the storage of the blog image, when “OK” is input through the information position specifying key 126, the file control section 20e may generate and store a normal image, while “NG” is input through the information position specifying key 126, the file control section 20e may discard the original image from the buffer memory 135.

At S16, a process similar to the above described S6 is performed.

Next, an image process which is performed corresponding to the specified image process through the detailed menu by the blog image generating section 20g will be explained in detail below.

### Case 1: where “Removal of Background” is Specified

At S12, when “Removal of Background (photographing of object)” is specified using a detailed menu, at S14, the outline extracting section 20g-2 recognizes an outline of a certain object from an original image which is newly obtained by the photographing at S13. Based on the recognize outline of the object, an image of the certain object is extracted to generate a blog image. When “Removal of Background (photographing of object)” is specified, if a focused object is within a predetermined close range, an image of the object may be photographed after a macro mode is set. In this case, if the image extracted by the outline extracting section 20g-2 has a size larger than the one specified through the menu, the conversion section 20g-1 may convert the image to have the specified size.

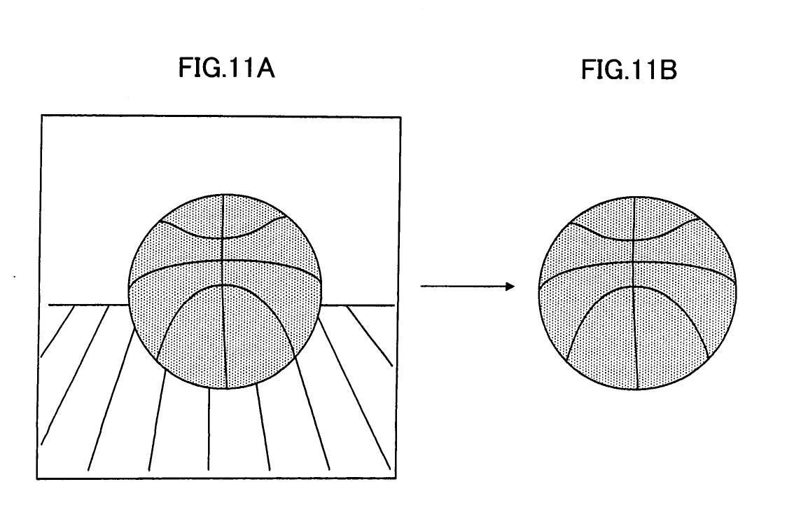

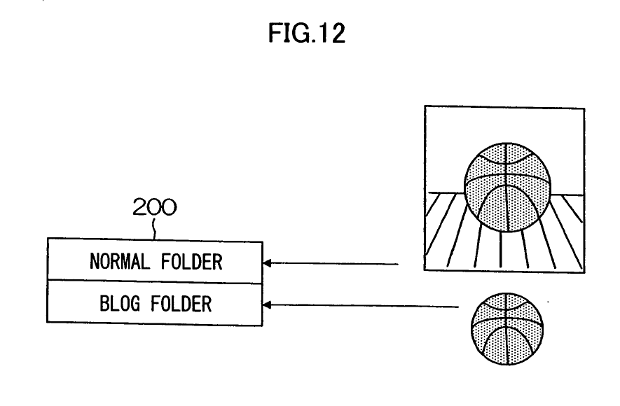

For example, as shown in FIG. 11A, when the certain object is a spherical ball, as shown in FIG. 11B, an image including the ball is extracted, which will be the blog image. Then as shown in FIG. 12, since a normal image is stored in a normal folder and a blog image is stored in a blog folder, respectively, the blog image from which an unnecessary background portion is removed is sent to the blog server 2.

However, an object may be sometimes extracted with less accuracy, and in such a case, a plurality of candidates obtained as results of the extraction may be listed, so that a user can specify one of them, and the specified image after extraction process can be stored as a blog image.

The certain object to be extracted is not limited to a ball, and may be a photograph of a movie poster or a doll for example.

As described above, only a certain object is extracted from an original image, so that the image from which an unnecessary portion is removed can be released on line as a blog image.

In addition, an image on which the extract process is not performed is retained in the normal folder, thereby the retained image can be used in applications such as photographic printing.

### Case 2: where “Privacy Protecting Process” is Specified

At S12, when “Privacy Protecting Process” is specified using a detailed menu, at S14, the face and eyes detecting section 20g-3 recognizes eyes of a person object from a newly obtained original image. Then the eye mask control section 20g-4 generates a blog image by performing a predetermined image process so that the eye area of the object is hidden.

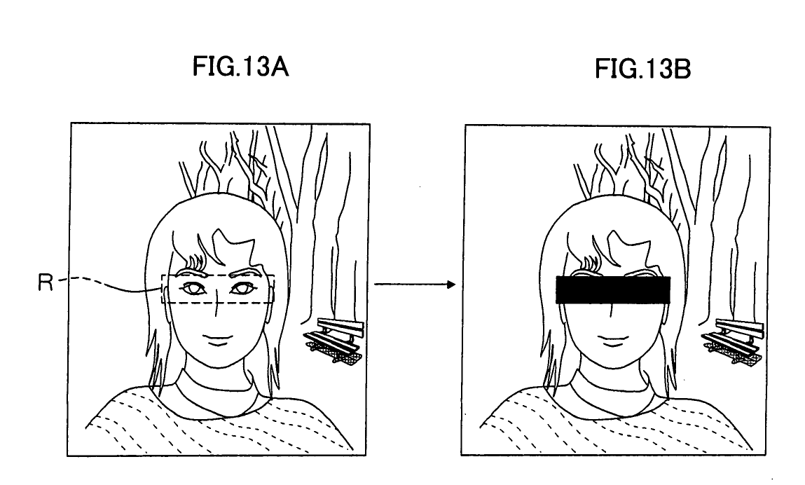

For example, when an eye area R is detected from a face of a person as shown in FIG. 13A, the eye mask control section 20g-4 synthesizes a black strip line onto the original image to hide the eye area of the object, and the conversion section 20g-1 converts the original image after the “Privacy Protecting Process” to have a specified size, so as to generate a blog image.

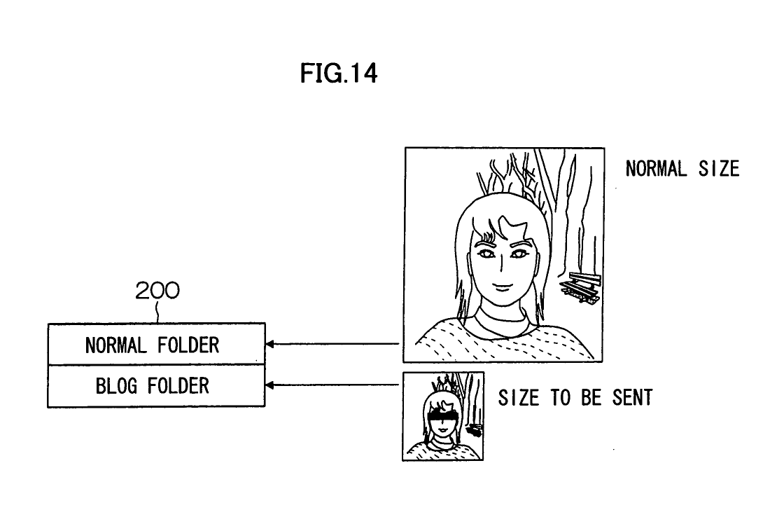

As shown in FIG. 14, since a normal image the eye area of which is not subjected to any image process is stored in a normal folder and the blog image is stored in a blog folder separately, the image having an eye area of a person which is difficult to recognize is sent to the blog server 2.

In this way, when an image having a face of a person is released to a blog site, the eyes of the person can be processed so that no one recognize the person, so as to protect the privacy and portrait right of the object.

In addition, an image on which the privacy protecting process is not performed is retained in the normal folder, thereby the retained image can be used in applications such as photographic printing.

### Case 3: where “Action Photograph” is Specified

At S12, when “Action Photograph” is specified using a detailed menu, and at S13 a plurality of original images are continuously photographed in the “Continuous Shooting Mode”, at S14, the conversion section 20g-1 converts each of the plurality of original images to have a specified blog size to generate blog images. The continuous shooting mode represents an operation for continuously obtaining a plurality of images by causing the AF/AE operation and the shutter operation by the CCD 132 to be repeatedly performed every predetermined period of time while the release switch 104 is continuously and fully pressed (so-called “Continuous Pressing”).

The Exif tag control section 20c records the information (continuous shooting information) that shows the images are a series of images photographed in one continuous shooting during one continuous pressing of the switch, at the header portion of the blog images which are generated based on the plurality of original image obtained by the continuous photographing in response to one continuous pressing, for example the tag portion of an Exif file.

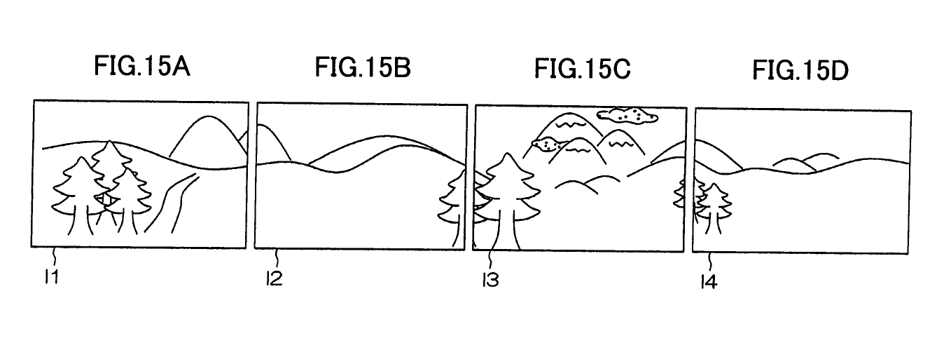

For example, a plurality of original images 11 to 14 as shown in FIGS. 15A to 15D are assumed to be obtained by a sequential photographing. The Exif tag control section 20c records common continuous shooting information (common serial numbers or letter strings) at the header portions of the Exif files in which the blog images J1 to J4 individually obtained from original images are stored. The Exif files may be provided with dedicated tags for storing the continuous shooting information.

The file for normal images may or may not have the recorded continuous shooting information.

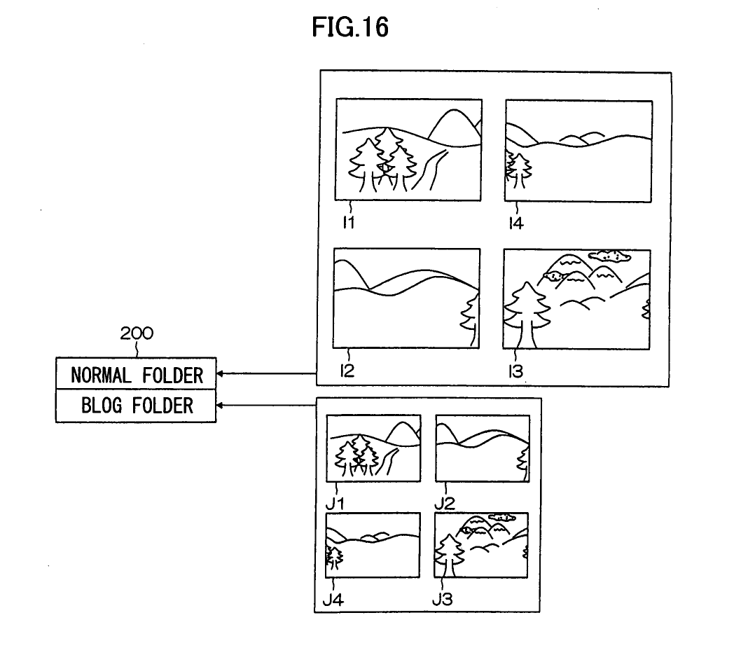

As shown in FIG. 16, since the folder control section 20d stores the files of the blog images J1 to J4 having the recorded continuous shooting information in the blog folder, and stores the normal images in the normal folder, the plurality of blog images J1 to J4 are sent to the blog server 2 at one time.

The blog server 2 is able to identify the images J1 to J4 photographed in one continuous shooting, using the continuous shooting information, among a plurality of blog images received from the camera 100.

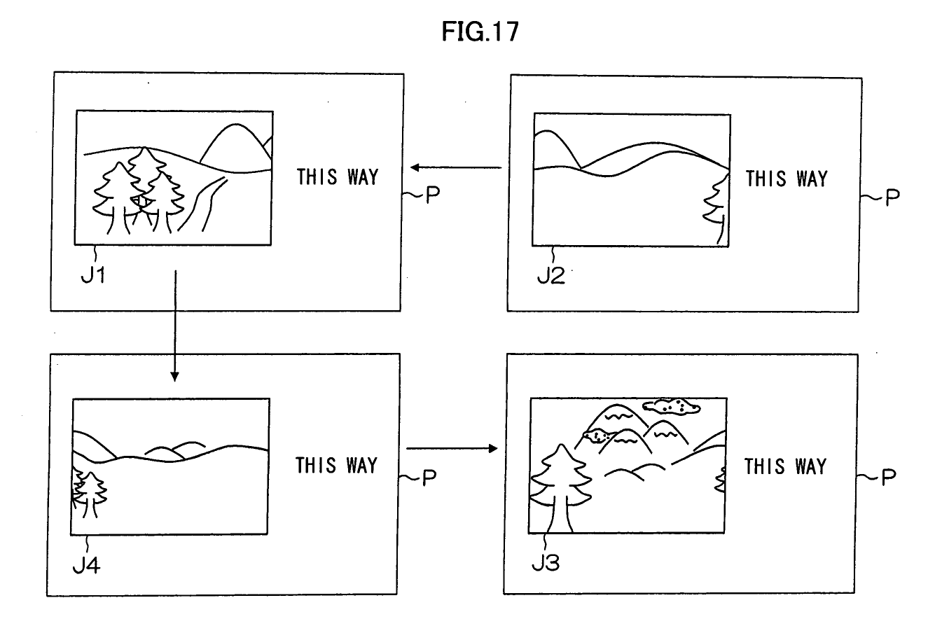

Upon the identification, as shown in FIG. 17, the blog server 2 is able to embed HTML tag information into an HTML file which makes up a blog page P, so that the series of blog images J1 to J4 photographed in one continuous shooting are serially reproduced at a receiver terminal (terminal for browsing) of the blog page P, for one second for one image for example, like a slide show.

Since the images which are photographed in one continuous shooting are serially displayed at the receiver terminal of the blog page P, a user can see the images photographed in one continuous shooting in the order of photographing one by one, which allows the user to enjoy the actions in the images.

### Case 4: where “Arrangement of Sequential Photographs” is Specified

When “Arrangement of Sequential Photographs” is specified using a detailed menu at S12, and a plurality of original images are continuously photographed in the “Continuous Shooting Mode” at S13, at S14, the image composition control section 20g-5 generates one blog image by combining the plurality of original images.

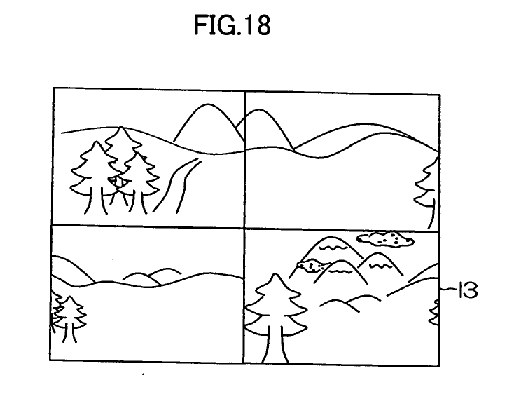

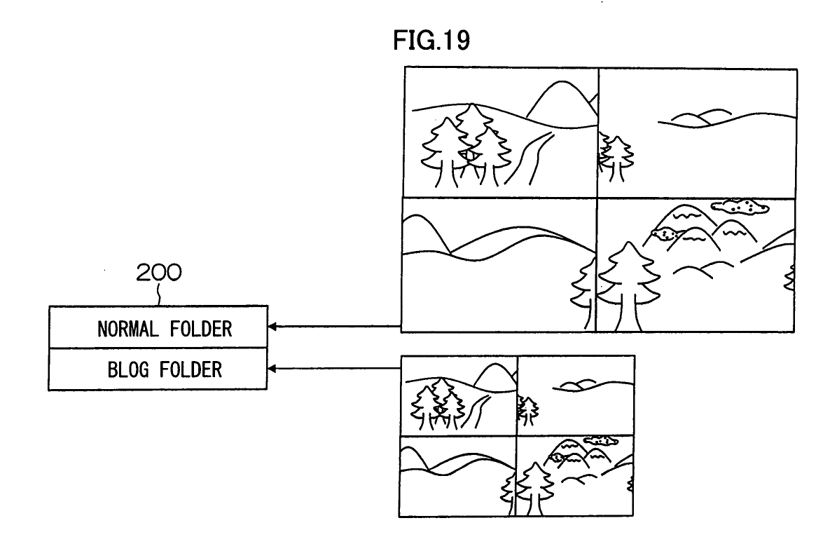

For example, assume that four original images 11 to 14 as shown in FIGS. 15A to 15D are photographed in one continuous shooting. In this case, as shown in FIG. 18, the image composition control section 20g-4 arranges the four original images 11 to 14 in a tiled pattern to combine (combined image), and the conversion section 20g-1 converts the combined image to have a blog size to generate a blog image B. The blog image B is stored in a blog folder. While, the file control section 20e converts each of the original images to have a normal size to generate normal images, or converts the combined image to have a normal image to generate a normal image to be stored in a normal folder.

As a result, the images photographed in one continuous shooting at one opportunity can be seen as one image at a blog site.

In addition, the image retained in the normal folder can be used in applications such as photographic printing.

### Case 5: where “Video Images” is Specified

At S12, when “Video images” is specified using a detailed menu, at S14, the conversion section 20g-1 converts an original image to have a specified size so that the resulting blog image has a size which is within a range of the preset video image file size, and then the file control section 20e creates a video image file based on the converted original image, the image of which is stored in a blog folder in the memory card 200 as a blog image.

Meanwhile, the file control section 20e creates a video image file which is not particularly limited by size or recording time, based on the original image, the image of which is stored in a normal folder as a normal image.

However, if the resulting image after the conversion of the original image by the conversion section 20g-1 has a size larger than the limit of the preset video image file size, the file control section 20e limits the recording time of the video image file under the preset video image file size, so that a video image for a blog is generated from the original image within the limited recording time.

As a result, a video image which has a size suitable to upload to the blog server 2 is automatically recorded without any care about the size of a video image by user.

In addition, a video image on which any special process is not performed is retained in the normal folder, thereby the retained image can be used in applications such as personal browsing.

### Case 6: where “Frame” is Specified

At S12, when “Frame” is specified using a detailed menu, at S14, first the frame control section 20g-6 composes an original image with a frame image which is specified from a menu in advance so that the frame image covers the original image. Then the conversion section 20g-1 converts the composed image to have a specified size to generate a blog image, which is stored in a blog folder.

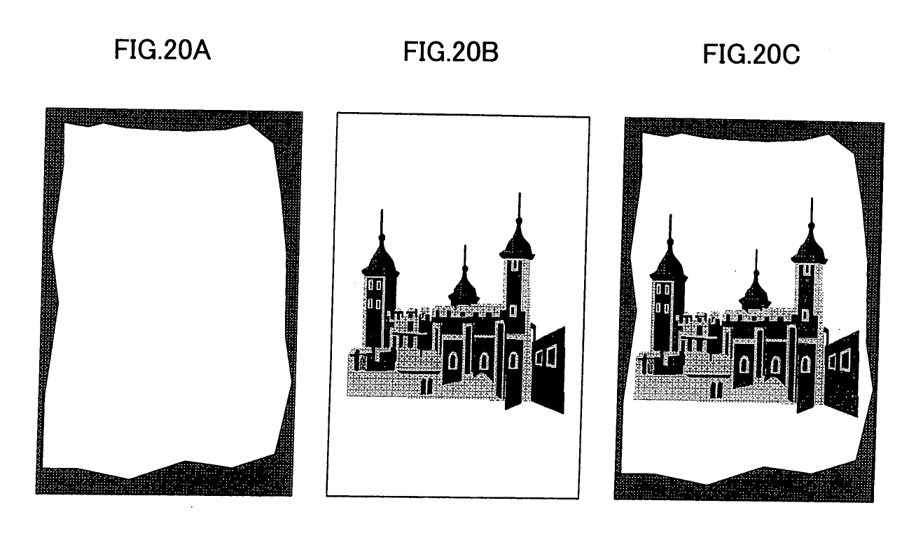

For example, with a frame image as shown in FIG. 20A and an original image as shown in FIG. 20B, the frame control section 20g-6 generates a composed image as shown in FIG. 20C and conveniently reduces the size, to store in a blog folder as a blog image.

Meanwhile, the file control section 20e generates a normal image which is not particularly composed with a frame image, based on the original image, which is stored in a normal folder.

In this way, a desired frame image is able to be composed with an image which is released to a blog.

In addition, an image which is not composed with a frame image is retained in the normal folder, thereby the retained image can be used in applications such as photographic printing.

What is claimed is:

1. A photographing apparatus, comprising:
a image pickup element for receiving an incident light from an object through a photographing lens and continuously converting the light to a photographing signal to output;
an image data converting section for converting the photographing signal which is output from the image pickup element to an image data to output;
a record indicating section for inputting a recording indication of the image data;
a shutter control section for controlling exposure of the image pickup element in response to the input of the recording indication at the record indicating section;
a storing section for storing the image data of the photographing signal output from the image pickup element in response to the exposure control by the shutter control section;
a displaying section for displaying at least the image data stored in the storing section;
a mode setting section for setting a weblog image recording mode which is a photographing mode for recording a weblog image of an image file to be released to a weblog site;
a folder creating section for separately creating a weblog folder which stores a weblog image, and a normal folder which stores a normal image of an image file for use in applications such as photographic printing and others except a release to the weblog site, in a predetermined recording medium;
a weblog image generating section for generating a weblog image by performing a predetermined process which is suitable to release an image data stored in the storing section to the weblog site, when the mode setting section sets a weblog image recording mode;
a normal image generating section for generating a normal image based on the image data stored in the storing section; and
a recording section for recording the normal image generated by the normal image generating section in the normal folder, and recording the weblog image generated by weblog image generating section in the weblog folder, individually.

2. The photographing apparatus according to claim 1, wherein
the weblog image generating section generates the weblog image by performing a conversion process for converting an image data stored in the storing section to have an image size suitable to release to the weblog site.

3. The photographing apparatus according to claim 1, wherein
the weblog image generating section generates the weblog image by recognizing an outline of a certain object from an image data stored in the storing section, and performing an object extracting process for extracting the image of the certain object along the outline of the certain object.

4. The photographing apparatus according to claim 2, wherein
the weblog image generating section generates the weblog image by recognizing an outline of a certain object from an image data stored in the storing section, and performing an object extracting process for extracting the image of the certain object along the outline of the certain object.

5. The photographing apparatus according to claim 1, wherein
the weblog image generating section generates the weblog image by recognizing an eye area of a person from an image data stored in the storing section, and performing an image process for making it prohibitively difficult to browse the eye area of the person.

6. The photographing apparatus according to claim 4, wherein
the weblog image generating section generates the weblog image by recognizing an eye area of a person from an image data stored in the storing section, and performing an image process for making it prohibitively difficult to browse the eye area of the person.

7. The photographing apparatus according to claim 1, wherein
the shutter control section repeatedly controls exposure of the image pickup element every predetermined period of time while the record indicating section is receiving a continuous input of recording indications, and
the blog image generating section generates a plurality of blog images by performing a continuous shooting information adding process for adding common continuous shooting information to each of the plurality of image data stored in the storing section in response to the continuous recording indications at one time which is input to the record indicating section.

8. The photographing apparatus according to claim 6, wherein
the shutter control section repeatedly controls exposure of the image pickup element every predetermined period of time while the record indicating section is receiving a continuous input of recording indications, and
the blog image generating section generates a plurality of blog images by performing a continuous shooting information adding process for adding common continuous shooting information to each of the plurality of image data stored in the storing section in response to the continuous recording indications at one time which is input to the record indicating section.

9. The photographing apparatus according to claim 1, wherein
the blog image generating section generates a blog image by performing a combining process for combining a plurality of image data stored in the storing section to one still image data in response to the plurality of recording indications input to the record indicating section.

10. The photographing apparatus according to claim 8, wherein
the blog image generating section generates a blog image by performing a combining process for combining a plurality of image data stored in the storing section to one still image data in response to the plurality of recording indications input to the record indicating section.

11. The photographing apparatus according to claim 1, wherein
the shutter control section continuously controls exposure of the image pickup element while the record indicating section is receiving a continuous input of recording indications, and
the blog image generating section performs a video image generating process for creating a video image file which is accommodated within a capacity limit of the weblog site based on the image data stored in the storing section in response to the continuous recording indications at one time which is input to the record indicating section.

12. The photographing apparatus according to claim 10, wherein
the shutter control section continuously controls exposure of the image pickup element while the record indicating section is receiving a continuous input of recording indications, and
the blog image generating section performs a video image generating process for creating a video image file which is accommodated within a capacity limit of the weblog site based on the image data stored in the storing section in response to the continuous recording indications at one time which is input to the record indicating section.

13. The photographing apparatus according to claim 1, wherein
the weblog image generating section generates the weblog image by performing a composing process for composing a predetermined frame image to an image data stored in the storing section.

14. The photographing apparatus according to claim 12, wherein
the weblog image generating section generates the weblog image by performing a composing process for composing a predetermined frame image to an image data stored in the storing section.

15. The photographing apparatus according to claim 1, further comprising:
a sending section for sending a weblog image recorded in the weblog folder to the weblog site in response to a connection to the weblog site; and
an eliminating section for eliminating the weblog image sent by the sending section from the weblog folder.

16. The photographing apparatus according to claim 14, further comprising:
a sending section for sending a weblog image recorded in the weblog folder to the weblog site in response to a connection to the weblog site; and
an eliminating section for eliminating the weblog image sent by the sending section from the weblog folder.

17. The photographing apparatus according to claim 1, wherein
the displaying section selectively displays image data of one of or both of a weblog image recorded in the weblog folder and a normal image recorded in the normal folder.

18. The photographing apparatus according to claim 16, wherein
the displaying section selectively displays image data of one of or both of a weblog image recorded in the weblog folder and a normal image recorded in the normal folder.

19. The photographing apparatus according to claim 1, further comprising:
a process specifying section for specifying a predetermined process which the weblog image generating section should perform in response to a setting of a weblog image recording mode by the mode setting section, so that the weblog image generating section performs the predetermined process specified by the process specifying section.

20. The photographing apparatus according to claim 18, further comprising:
a process specifying section for specifying a predetermined process which the weblog image generating section should perform in response to a setting of a weblog image recording mode by the mode setting section, so that the weblog image generating section performs the predetermined process specified by the process specifying section.

21. The photographing apparatus according to claim 19, wherein
the predetermined process specified by the process specifying section includes at least one of a conversion process, an object extracting process, an image process for making it prohibitively difficult to browse an eye area of an object person, a continuous shooting information adding process for adding common continuous shooting information to each of the plurality of image data obtained in response to one recording indication, a combining process for combining a plurality of image data to one still image data, a video image generating process for generating video image file which is accommodated within a capacity limit of the weblog site, and a composing process for composing a predetermined frame image.

22. A photographing method which is used in a photographing apparatus, including: a image pickup element for receiving an incident light from an object through a photographing lens and continuously converting the light to a photographing signal to output; an image data converting section for converting the photographing signal which is output from the image pickup element to an image data to output; a record indicating section for inputting a recording indication of the image data; a shutter control section for controlling exposure of the image pickup element in response to the input of the recording indication at the record indicating section; a storing section for storing the image data of the photographing signal output from the image pickup element in response to the exposure control by the shutter control section; and a displaying section for displaying at least the image data stored in the storing section, and
the photographing method, comprising the steps of:
setting a weblog image recording mode which is a photographing mode for recording a weblog image of an image file to release on a weblog site;
creating a weblog folder which stores a weblog image, and a normal folder which stores a normal image of an image file for use in applications such as photographic printing and others except a release to a weblog site, individually in a predetermined recording medium;
generating a weblog image by performing a predetermined process on an image data stored in the storing section which is suitable to release the image data to the weblog site, when the mode setting section sets the weblog image recording mode;
generating a normal image based on an image data recorded in the storing section; and
recording the normal image generated by the normal image generating section into the normal folder, and recording the weblog image generated by the weblog image generating section into the weblog folder, individually.
